(19) United States
(12) Patent Application Publication
(10) Pub. No.: US 2013/0334089 A1
(43) Pub. Date: Dec. 19, 2013

(54) Glass Container Insulative Coating

(71) Applicant: Michael P. Remington, JR., Toledo, OH (US)

(72) Inventor: Michael P. Remington, JR., Toledo, OH (US)

(21) Appl. No.: 13/524,599

(22) Filed: Jun. 15, 2012

(51) Int. Cl. C03C 17/245; B05D 5/00; B05D 3/00; B65D 25/34

(52) U.S. Cl. 206/524.3; 65/60.2; 427/126.3; 427/160

(57) ABSTRACT

A glass container and related methods of manufacturing and coating glass containers. The container includes an axially closed base at an axial end of the container, a body extending axially from the closed base and being circumferentially closed, and an axially open month at another end of The container opposite of the base. An exterior surface of the container includes an infrared insulative coating including at least one of a metal or a transparent conductive oxide (TCO), wherein the metal is selected from the group consisting of silver, gold, and aluminum, and wherein the TCO is selected from the group consisting of SnO₂:Sb, SnO₂:F, In₂O₃:Sn, ZnO:F, ZnO:Al, and ZnO:Ga.

The present disclosure is directed to glass containers, manufacturing processes for glass containers, and to coating processes for glass containers including methods and materials for coating glass containers (e.g., glass bottles and jars).

### BACKGROUND AND SUMMARY OF THE DISCLOSURE

Various processes have been developed to apply coatings to glass containers for different purposes, including decoration, adhesion and glass strengthening for damage prevention. For example, U.S. Pat. No. 3,522,075 discloses a process for coating a glass container in which the container is formed, coated with a layer of metal oxide such as tin oxide, cooled and annealed through a lehr, and then coated with an organopolysiloxane resin-based material over the metal oxide layer. In another example, U.S. Pat. No. 3,912,100 discloses a method of making a glass container by heating the glass container and applying a polyurethane powder spray to the glass container.

A general object of the present disclosure, in accordance with one aspect of the disclosure, is to provide an improved method of coating containers to impart insulating properties to the containers to maintain colder or lower temperatures of contents in the containers for a longer time without changing aesthetics of the containers, for instance, by using a separate, external insulation sleeve or label.

The present disclosure embodies a number of aspects that can be implemented separately from or in combination with each other.

A process for applying a low-e coating to a glass container in accordance with one aspect of the disclosure includes the following steps: (a) preparing a low-e coating including at least one of a metal or a transparent conductive oxide (TCO), wherein the metal is selected from the group consisting of silver, gold, and aluminum, and wherein the TCO is selected from the group consisting of SnO₂:Sb, SnO₂:F, In₂O₃:Sn, ZnO:F, ZnO:Al, and ZnO:Ga; and (b) applying the low-e coating to the external surface of the glass container.

A method of coating a glass container in accordance with one aspect of the disclosure includes the following steps: (a) depositing on an exterior surface of the container, a coating including at least one of a metal or a transparent conductive oxide (TCO), wherein the metal is selected from the group consisting of silver, gold, and aluminum, and wherein the TCO is selected from the group consisting of SnO2:Sb, SnO2:F, In₂O₃:Sn, ZnO:F, ZnO:Al, and ZnO:Ga, to impart insulating properties to the container; and (b) applying a cold-end coating to the exterior surface of the container after step (a).

In accordance with another aspect of the disclosure, a method of coating an exterior surface of a glass container includes the following steps: (a) depositing a hot-end coating on an exterior surface of the container; and (b) applying a low-e coating to the exterior surface of the container after step (a), wherein the low-e coating includes particles composed of at least one of metal or transparent conductive oxide (TCO), wherein the metal is selected from the group consisting of silver, gold, and aluminum, and wherein the TCO is selected from the group consisting of SnO₂:Sb, In₂O₃:Sn, ZnO:Al, and ZnO:Ga.

In accordance with a further aspect of the disclosure, there is provided a glass container that includes a closed base at one axial end of the container, a body extending axially from the closed base and being circumferentially closed, and an open mouth at another axial end of the container opposite of the base. An exterior surface of the container includes an infrared insulative coating including at least one of a metal or a transparent conductive oxide (TCO), wherein the metal is selected from the group consisting of silver, gold, and aluminum, and wherein the TCO is selected from the group consisting of SnO₂:Sb, SnO₂:F, In₂O₃:Sn, ZnO:F, ZnO:Al, and ZnO:Ga.

In accordance with an additional aspect of the disclosure, there is provided a method of manufacturing a glass container including the following steps: (a) forming the container; and then (b) applying a coating to an exterior surface of the container to impart insulating properties to the container, wherein the coating includes at least one of a metal or a transparent conductive oxide (TCO), wherein the metal is selected from the group consisting of silver, gold, and aluminum, and wherein the TCO is selected from the group consisting of SnO2:Sb, SnO2:F, In₂O₃:Sn, ZnO:F, ZnO:Al, and ZnO:Ga, to impart insulating properties to the container; and then (c) applying a cold-end coating to the exterior surface of the container.

In accordance with yet another aspect of the disclosure, there is provided a method of manufacturing a glass container including the following steps: (a) forming the container; and then (b) applying a hot-end coating to an exterior surface of the container; and then (c) annealing the container; and then (d) depositing a low-e coating on the container to impart insulating properties to the container, wherein the low-e coating includes particles composed of at least one of metal or transparent conductive oxide (TCO), wherein the metal is selected from the group consisting of silver, gold, and aluminum, and wherein the TCO is selected from the group consisting of SnO₂:Sb, In₂O₃:Sn, ZnO:Al, and ZnO:Ga.

### BRIEF DESCRIPTION OF THE DRAWING

The disclosure, together with additional objects, features, advantages and aspects thereof, will be best understood from the following description, the appended claims and the accompanying drawings, in which:

FIG. 1 is an elevational view of a glass container in accordance with an illustrative embodiment of the present disclosure;

FIG. 2 is a cross-sectional view of the glass container body;

FIG. 3A shows one illustrative embodiment of an enlarged sectional view of the glass container, taken from circle 3 of FIG. 1;

FIG. 3B shows a further illustrative embodiment of an enlarged sectional view of the glass container, taken from circle 3 of FIG. 1;

FIG. 3C shows another illustrative embodiment of an enlarged sectional view of the glass container, taken from circle 3 of FIG. 1;

FIG. 4 is a flow diagram of a glass container manufacturing process;

FIG. 5 is a flow diagram of a glass container manufacturing process in accordance with one illustrative embodiment of the present disclosure, wherein a low-e coating replaces a conventional hot-end coating and is applied before an annealing step;

FIG. 6 is a flow diagram of a glass container manufacturing process in accordance with another illustrative embodiment of the present disclosure, wherein a low-e coating replaces a conventional hot-end coating and is applied after an annealing step; and

FIG. 7 is a flow diagram of a glass container manufacturing process in accordance with an additional illustrative embodiment of the present disclosure, wherein a low-e coating is applied after an annealing step.

### DETAILED DESCRIPTION OF PREFERRED EMBODIMENTS

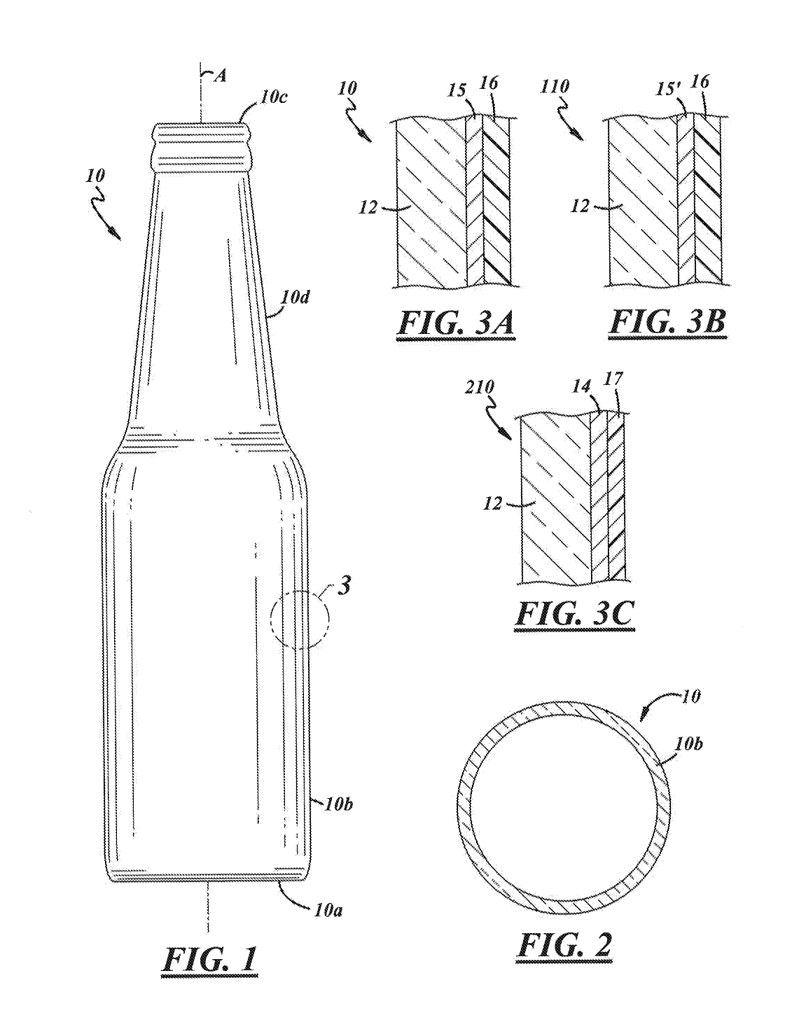

FIG. 1 shows an illustrative embodiment of a glass container 10 (e.g., glass bottle, jar, or the like) that may be produced in accord with an illustrative embodiment of a manufacturing process presently disclosed hereinbelow. The glass container 10 includes a longitudinal axis A, a base 10a at one axial end of the container 10 that is closed in an axial direction, a body 10b extending in an axial direction from the axially closed base 10a, and a mouth 10c at another axial end of the container 10 opposite of the base 10a. Accordingly, the glass container 10 is hollow. In the illustrated embodiment, the container 10 also includes a neck 10d that may extend axially from the body 10b, may be generally conical in shape, and may terminate in the mouth 10c. However, the container 10 need not include the neck 10d and the mouth 10c may terminate the body 10b, such as in a glass jar embodiment or the like. The body 10b may be of any suitable shape in cross-section transverse to the axis A as long as the body 10b is circumferentially closed.

For example, as shown in FIG. 2, the body 10b may be of cylindrical transverse cross-sectional shape that is circumferentially closed. In other embodiments, the body 10b may be generally oval, square, rectangular, triangular, or of any other suitable transverse cross-sectional shape. As used herein, the term “circumferentially” applies not only to circular transverse cross-sectional shapes but also applies to any closed transverse cross-sectional shape.

FIG. 3A represents an illustrative embodiment of the glass container 10, wherein the container 10 includes a glass substrate 12, a hot end low-e coating 15 applied to an exterior surface of the container 10 on the substrate 12, and a cold-end coating 16 applied to the exterior surface of the container 10 over the low-e coating 15. As used herein, the term “low-e” coating may include a low emissivity coating to reflect, or otherwise attenuate, radiation in an infrared or near-infrared portion of the light spectrum, as will be described in greater detail below.

FIG. 3B represents a further illustrative embodiment of a glass container 110, wherein the container 110 includes the glass substrate 12, a post-anneal low-e coating 15 applied to an exterior surface of the container 10 on the substrate 12, and the cold-end coating 16 applied to the exterior surface of the container 10 over the low-e coating 15′.

FIG. 3C represents another illustrative embodiment of a glass container 210, wherein the container 210 includes the glass substrate 12, a hot-end coating 14 applied to the exterior surface of the container 10 on the substrate 12, and a post-anneal low-e coating 17 applied to the exterior surface of the container 10 after a cold-end coating (not shown) has been previously applied and removed or to replace a cold-end coating (not shown).

A prior art glass container with conventional hot-end and cold-end coatings would allow substantial transmission of infrared (IR) and near-infrared (NIR) radiation. As used herein, for the sake of simplicity, the term “infrared” includes infrared and near-infrared radiation. In one example, the IR wavelength includes 800 nm to 1,000 μm, and the NIR wavelength includes 800 nm to 2 μm. In a more particular example, the IR wavelength includes 800 nm to 30 μm.

According to the present disclosure, however, the glass container 10 may include the low-e coating 15 (or 15′) to replace a conventional hot-end coating applied before application of the cold-end coating 16 (e.g. FIGS. 3A and 3B), or may include the low-e coating 17 instead of the cold-end coating (e.g. FIG. 3C). Therefore, the low-e coatings 15, 15′, 17 may impart insulating properties to the container 10 to maintain colder or lower temperatures of contents in the container 10 for a longer time than otherwise would be possible without the coating(s) and without a separate, external insulating element on the container 10. In other words, the coatings 15, 15′, 17 may provide good protection from IR/NIR energy entering a cold interior of the container 10 to keep beverages colder, longer.

Although the various coatings 14 through 17 are shown as adjacent layers overlying one another sequentially, one or more of the coatings 14 through 17 may penetrate into or even through one or more of the other coatings. Accordingly, the various coatings 14 through 17 may be fairly described as being applied generally to the glass container 10, regardless of how or to what extent any given coating contacts any of the other coatings and/or the substrate 12. Similarly, when a material is described as being applied to an exterior surface of the glass container 10, the material may be applied over one or more of the coatings 14 through 17 and/or the glass substrate 12 itself.

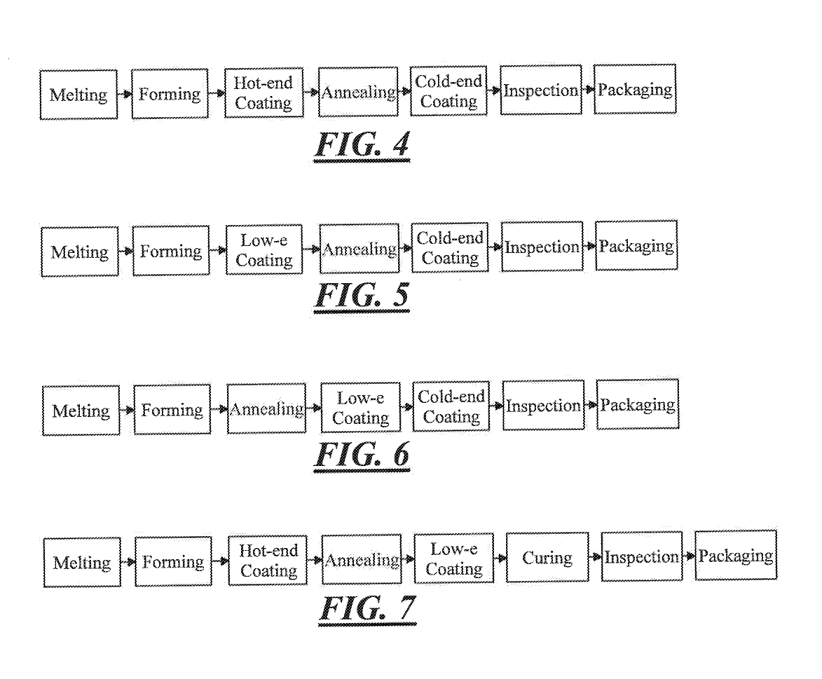

With reference to FIG. 4, glass containers can he produced in any suitable manner. Typical glass container manufacturing includes a “hot end” that may include producing a glass melt using one or more melting furnaces, forming the glass melt into glass containers using forming machines, and applying a hot-end coating to the glass containers. The “hot end” also may include an annealing lehr, or at least a beginning portion of the annealing lehr, and annealing the glass containers therein. At an entry, hot end, or upstream portion of the annealing lehr, the temperature therein may be between 750 and 550 degrees Celsius. Through the lehr, the temperature may be brought down gradually to a downstream portion, cool end, or exit of the lehr, for example, to a temperature therein of between 130 degrees Celsius and 65 degrees Celsius.

Typical glass container manufacturing also involves a “cold end” that may include an end portion of an annealing lehr, inspection equipment, and packaging machines. Also, the cold end may include application of a cold-end coating to the glass containers downstream of the annealing lehr. For example, the glass containers may be coated with the cold-end coating, which may be a protective organic coating applied downstream of the annealing lehr. The cold-end coating may include a polyethylene material, like a polyethylene wax or the like, stearate, oleic acid, and/or any other suitable cold-end coating material(s). After the cold-end coating is applied, production also may include inspecting the glass containers for any suitable characteristics and using inspection equipment. For example, the glass containers may be manually or automatically inspected for cracks, inclusions, surface irregularities, hot end and/or cold-end coating properties, and/or the like. After inspection, the glass containers may be packaged using any suitable packaging machines.

Accordingly, a “hot end” coating is a coating applied at the hot end of the glass container manufacturing process, and a “cold end” coating is a coating applied at the cold end of the glass container manufacturing process.

With general reference to FIG. 5, and according to a first embodiment, the containers may be provided with a low-e coating generally in the hot end of the glass container manufacturing process, upstream of the application of the cold-end coating. For example, after forming a plurality of the glass container 10 with forming machines, the glass containers may be coated in any suitable manner with any suitable low-e coating materials to produce the low-e coating 15 of FIG. 3A. In this embodiment, the low-e coating replaces a conventional hot-end coating and is applied before and/or during an annealing step. For example, the glass containers may be coated, for instance, under a hood between the forming machines and an annealing lehr, in the annealing lehr, or under a hood in a line branched out of and back into the annealing lehr.

The low-e coating 15 may be an inorganic coating and may be applied to the container by chemical vapor deposition (CVD), or by any other suitable technique. Also, the low-e coating 15 may be applied as a stack of multiple layers.

In one implementation of the hot end low-e coating embodiment, the low-e coating 15 may include a CVD stack including a transparent conductive oxide (TCO). In one example, the TCO CVD coating stack may be applied as a “hot end” coating upstream of the annealing lehr using latent heat of the containers to affect decomposition of precursors of the coating 15. Accordingly, the CVD stack may be applied in a pyrolytic process, and may include a relatively thick TCO layer on the order of 250 to 400 nm and one or more relatively thin color suppression layers having a total thickness on the order of 10 to 30 nm.

For instance, the TCO may include an oxide of tin (Sn), indium (In), or zinc (Zn), and the low-e coating 15 of this embodiment also may include any suitable dopants. Examples follow.

In a first example, the metal oxide may include SnO₂ and the dopant may include fluorine (F) or antimony (Sb). In a particular example, a tin oxide may be provided from a gaseous form of monobutyl tin trichloride. The resulting coating 15 may have a generic formula of SnO₂:D where D is the dopant atom. The dopant atoms may be provided from any suitable dopant molecules. For example, hydrogen fluoride, tri-fluoro acetic acid (TPA), or the like, may be used to provide a fluoride dopant. In another example, antimony trichloride (SbCl₃), antimony pentachloride (SbCl₅), triphenyl antimony ((C₆H₅)₃Sb), or the like, may be used to provide an antimony dopant. A simplified example of a CVD low-e coating stack may include glass/SnO₂/SiO₂/SnO₂:F, wherein the glass is the container glass, the SnO₂ and the SiO2 are the relatively thin color suppression layers, and the SnO₂:F is the relatively thick TCO layer.

In a second example, the metal oxide may include In₂O₃ and the dopant may include tin. In other words, the coating 15 may be a tin-doped indium oxide, or indium tin oxide (ITO). The dopant atoms may be provided from any suitable dopant molecules.

In a third example, the metal oxide may include ZnO and the dopant may include fluorine (F), aluminum (Al), or gallium (Ga). The dopant atoms may be provided from any suitable dopant molecules. For ZnO based TCOs, it may be desirable to deposit a protective layer over the CVD stack. For example, the protective layer may include SiO₂ or any suitable inert metal oxide.

During deposition of the low-e coating 15, molecular precursors of the dopant may be added into a gas phase of the metal oxide precursor, for example, by CVD. Any suitable source of the dopant molecules or precursor and any suitable means to vaporize the dopant precursor may be used. In one embodiment, the dopant precursor may be vaporized in a hot-end coating hood depending on vapor pressure of the precursor. In another embodiment, the precursor may be volatilized separately and then delivered to the hot-end coating hood. Once vaporized, the dopant precursor gas may be mixed with the metal oxide gas, for example, in the hot-end coating hood. Where the resulting low-e coating ay be deposited onto the containers.

With reference to FIGS. 6 and 7, and according to a second embodiment, the containers may be provided with a low-e coating after annealing of the containers (post-anneal) and generally in the cold end of the glass container manufacturing process.

With specific reference to FIG. 6, there is illustrated a glass container manufacturing process in accordance with one implementation of the second embodiment. For example, the glass containers may be coated in any suitable manner with any suitable low-e coating materials to produce the low-e coating 15 of FIG. 313. In this implementation, the low-e coating 15′ may replace a conventional hot-end coating and is applied after annealing step. For example, the glass containers may be coated with the low-e coating, for instance, under a hood between the annealing lehr and a location upstream of where the containers enter bulk-flow where the containers undergo container-to-container contact. More specifically, the containers may be coated with the low-e coating just upstream of where a cold-end coating is applied to the containers.

In one implementation of the post-anneal low-e coating embodiment, the low-e coating 15 may be applied by physical vapor deposition (PVD), for example PVD sputtering. Accordingly, the low-e coating 15′ may include a PVD stack including an active layer between dielectric layers, which may serve as anti-reflective and/or protective layers. In one example, the active layer may include a metal, for example, silver (Ag), gold (Au), or aluminum (Al), and the dielectric layers may include silica (SiO₂). Accordingly, a simplified example of a PVD low-e coating stack may include glass/SiO₂/metal/SiO₂, wherein the glass is the container glass, the SiO₂ are silica layers that may be applied in any suitable manner, and the metal layer is the active layer.

In another implementation of the post-anneal low-e coating embodiment, the low-e coating 15′ may include a CVD stack including a transparent conductive oxide (TCO). In this implementation, assisted or activated CVD techniques may be used and may include combustion CVD, plasma enhanced CVD, or the like. Accordingly, the CVD stack may be applied in a pyrolytic process, and may include a relatively thick TCO layer on the order of 250 to 400 nm and one or more relatively thin color suppression layers having a total thickness on the order of 10 to 30 nm. The CVD stack may include doped metal oxides, as already discussed above with respect to the hot end low-e coating 15.

With specific reference to FIG. 7, there is illustrated a glass container manufacturing process in accordance with a second implementation of the post-anneal low-e coating embodiment. For example, the glass containers may be coated in any suitable manner with any suitable low-e coating materials to produce the low-e coating 17 of FIG. 3C. In this implementation, the post-anneal lo coating 17 replaces the cold end coating. For example, the glass containers may be coated with the post-anneal low-e coating 17, for instance, under a hood in a cold end of the container manufacturing process.

The low-e coating 17 may be applied to exterior surfaces of the glass containers in any suitable manner and by any suitable equipment for IR/NIR protection. The coating 17 may be applied, for example, before inspection. The post-anneal low-e coating 17 may be applied by spraying, dipping, powder coating, electrostatic coating, or other suitable techniques. The post-anneal low-e coating 17 may be based on one or more of a variety of polymers including acrylates, epoxies, urethanes, and/or the like. The coating 17 instead may be based on one or more of a variety of silanes.

In a first example of the second implementation of the post-anneal coating embodiment, the second post-anneal coating 17 may include metal particles dispersed in a polymer base or silane base. For example, the coating 17 may include nano-particles of silver (Ag), gold (Au), or aluminum (Al).

In a second example of the second implementation of the post-anneal coating embodiment, the post-anneal low-e coating 17 may include TCO particles dispersed in the polymer base or silane base. For example, the TCO may include oxides of indium (In), zinc (Zn), or tin (Sn). Also, the TCO low-e coating 17 of this embodiment also may include a suitable dopant. In a first example, the metal oxide may include In₂O₃ and the dopant may include tin. In a second example, the metal oxide may include ZnO and the dopant may include aluminum (Al) or gallium (Ga). In a third example, the metal oxide may include SnO₂ and the dopant may include antimony (Sb).

Also, for good distribution of the metal or TCO particles within the polymer or silane and to prevent agglomeration, the particles may be capped, passivated, and/or functionalized with a suitable organic based ligand.

The metal or TCO particles may represent 1 to 10 by weight of the coating material before it is applied to the containers. More particularly, the metal or TCO particles may be about 2 to 7% by weight of the coating material before application. In a more specific implementation, the metal or TCO particles may be about 3 to 5% by weight of the coating material before application.

In one embodiment, the post-anneal low-e coating 17 may be applied in conditions under 150 degrees Fahrenheit and, preferably, at an ambient temperature. As used herein, the terminology “ambient temperature” may include the temperature of the surrounding container manufacturing environment.

After applying the post-anneal low-e coating 17, the glass containers may be cured in any suitable manner. For example, the post-anneal low-e coating 17 may be a radiation-curable organic coating cured by any suitable type of radiation like, for instance, ultraviolet or electron beam radiation. In another embodiment, the post-anneal low-e coating 17 may be a thermally-curable coating cured by convection oven, infrared lamps, or the like.

After curing, the glass containers may be filled and packaged or simply packaged in any suitable manner.

The glass container manufacturing process may or may not include all of the disclosed steps or be sequentially processed or processed in the particular sequence discussed, and the presently disclosed manufacturing process and coating methods encompass any sequencing, overlap, or parallel processing of such steps. Also, the various embodiments may be provided in any suitable combinations with one another.

The present disclosure provides an advancement in the art. Conventionally, it has been understood that successful insulation of glass containers required separate, external insulating elements like foam sleeves or labels to impart insulating properties to the containers. Contrary to conventional wisdom, it is now possible to produce transparent, substantially colorless, glass containers with improved insulating properties, but without having to use separate, external insulating elements that are opaque and detract from the transparent, pure appearance of a glass container. In contrast, the use of at least one of the low-e coatings of the presently disclosed method provides a simple but elegant solution to a problem in the art of glass container manufacturing that has long been experienced but apparently unappreciated.

There thus has been disclosed methods of coating glass containers and methods of manufacturing glass containers that at least partially satisfy one or more of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A process for applying a low-e coating to a glass container having an external surface, which includes the steps of:
(a) preparing a low-e coating including at least one of a metal or a transparent conductive oxide (TCO), wherein the metal is selected from the group consisting of silver, gold, and aluminum, and wherein the TCO is selected from the group consisting of SnO₂:Sb, SnO₂:F, In₂O₃:Sn, ZnO:F, ZnO:Al, and ZnO:Ga; and
(b) applying the coating to the external surface of the glass container.

2. The process set forth in claim 1 wherein the applying step (b) is carried out at a hot end of a glass container manufacturing process.

3. The process set forth in claim 2 wherein the applying step (b) is carried out before the glass container is annealed in the glass container manufacturing process.

4. The process set forth in claim 1 wherein the preparing step (a) includes the TCO and the applying step (b) includes chemical vapor deposition of the TCO to the glass container.

5. The process set forth in claim 1 wherein the applying step (b) is carried out at a cold end of a glass container manufacturing process.

6. The process set forth in claim 5 wherein the applying step (b) is carried out after the glass container is annealed in the glass container manufacturing process.

7. The process set forth in claim 6 wherein the preparing step (a) includes the metal and the applying step (b) includes physical vapor deposition of the metal to the glass container.

8. The process set forth in claim 5 wherein the at least one of a metal or a TCO is provided as particles in at least one of a polymer solution or silane solution.

9. The process set forth in claim 8 including curing the at least one of a polymer or silane solution to form a transparent external coating on the container that reflects or otherwise attenuates infrared energy.

10. A method of coating an exterior surface of a glass container, which includes the steps of:
(a) depositing on an exterior surface of the container, a coating including at least one of a metal or a transparent conductive oxide (TCO), wherein the metal is selected from the group consisting of silver, gold, and aluminum, and wherein the TCO is selected from the group consisting of SnO2:Sb, SnO2:F, In₂O₃:Sn, ZnO:F, ZnO:Al, and ZnO:Ga, to impart insulating properties to the container; and
(b) applying a cold-end coating to the exterior surface of the container after step (a).

11. The method set forth in claim 10 wherein the depositing step (a) is carried out before the glass container is annealed in the glass container manufacturing process.

12. The method set forth in claim 11 wherein the depositing step (a) includes chemical vapor deposition of the TCO on the exterior surface of the glass container.

13. The method set forth in claim 10 wherein the depositing step (b) is carried out after the glass container is annealed in the glass container manufacturing process.

14. The method set forth in claim 13 wherein the depositing step (a) includes physical vapor deposition of the metal to the glass container.

15. A glass container, made by the method set forth in claim 10.

16. A method of coating an exterior surface of a glass container, which includes the steps of:
(a) depositing a hot-end coating on an exterior surface of the container; and
(b) applying a low-e coating to the exterior surface of the container after step (a), wherein the low-e coating includes particles composed of at least one of metal or transparent conductive oxide (TCO), wherein the metal is selected from the group consisting of silver, gold, and aluminum, and wherein the TCO is selected from the group consisting of SnO₂:Sb, In₂O₃:Sn, ZnO:Al, and ZnO:Ga.

17. The method set forth in claim 16 wherein the low-e coating includes the particles in at least one of a polymer solution or a silane solution.

18. The method set forth in claim 17 including curing the at least one of a polymer solution or silane solution to form a transparent external coating on the container that reflects or otherwise attenuates infrared energy.

19. The method set forth in claim 18, wherein step (b) is tarried out at an ambient temperature.

20. The method set forth in claim 19, wherein step (b) is carried out at less than 150 degrees Fahrenheit.

21. A glass container made by the method set forth in claim 16.

22. A glass container that includes:
a closed base at an axial end of the container;
a body extending axially from the closed base and being circumferentially closed; and
an open mouth another end of the container opposite of the base;
wherein an exterior surface of the container includes an infrared insulative coating including at least one of a metal or a transparent conductive oxide (TCO), wherein the metal is selected from the group consisting of silver, gold, and aluminum, and wherein the TCO is selected from the group consisting of SnO₂:Sb, SnO₂:F, In₂O₃:Sn, ZnO:F, ZnO:Al, and ZnO:Ga.

23. A method of manufacturing a glass container, which includes the steps of:
(a) forming the container; and then
(b) applying a coating to an exterior surface of the container to impart insulating properties to the container, wherein the coating includes at least one of a metal or a transparent conductive oxide (TCO), wherein the metal is selected from the group consisting of silver, gold, and aluminum, and wherein the TCO is selected from the group consisting of SnO2:Sb, SnO2:F, In₂O₃:Sn, ZnO:F, ZnO:Al, and ZnO:Ga, to impart insulating properties to the container; and then
(c) applying a cold-end coating to the exterior surface of the container.

24. The method set forth in claim 23 wherein the applying step (b) is carried out before a step of annealing the container.

25. The method set forth in claim 23 wherein the applying step (b) is carried out after a step of annealing the container.

26. A glass container made by the method set forth in claim 23.

27. A method of manufacturing a glass container, which includes the steps of:
(a) forming the container; and then
(b) applying a hot-end coating to an exterior surface of the container; and then
(c) annealing the container; and then
(d) depositing a low-e coating on the container to impart insulating properties to the container, wherein the low-e coating includes particles composed of at least one of metal or transparent conductive oxide (TCO), wherein the metal is selected from the group consisting of silver, gold, and aluminum, and wherein the TCO is selected from the group consisting of SnO₂:Sb, In₂O₃:Sn, ZnO:Al, and ZnO:Ga.

28. The method set forth in claim 27 including wherein the at least one of a metal or a TCO is provided as particles in at least one of a polymer solution or silane solution, and also including (e) curing the at least one of a polymer or silane solution to form a transparent external coating on the container that reflects or otherwise attenuates infrared energy.

29. The method set forth in claim 27 wherein the particles represent 1 to 10% by weight of the coating material before it is applied to the containers.

30. The method set forth in claim 27 wherein the particles represent 2 to 7% by weight of the coating material before it is applied to the containers.

31. The method set forth in claim 27 wherein the particles represent 3 to 5% by weight of the coating material before it is applied to the containers.

32. A glass container made by the method set forth in claim 27.
